(19) United States
(12) Patent Application Publication
(10) Pub. No.: US 2014/0346026 A1
(43) Pub. Date: Nov. 27, 2014

(54) SWITCH AND CONTROL METHOD THEREOF

(71) Applicant: OMRON CORPORATION, Kyoto-shi (JP)

(72) Inventors: Yasuhiro SAKASHITA, Okayama-City (JP); Yasuhiro KIYONO, Nagaokakyo-City (JP)

(73) Assignee: OMRON CORPORATION, Kyoto-shi (JP)

(21) Appl. No.: 14/246,813

(22) Filed: Apr. 7, 2014

(30) Foreign Application Priority Data
May 22, 2013 (JP) 2013-108099

(51) Int. Cl. H01H 3/22

(52) U.S. Cl. CPC H01H 3/22
USPC 200/518

(57) ABSTRACT

A switch and a method for controlling the switch, the switch including a movable touch piece configured to be turned by manual operation of an operation button, a movable contact that is provided in the movable touch piece and configured to be brought into contact with and separated from a fixed contact to close and open a contact, and a remote control unit configured to be able to operate the operation button by remote control, the remote control unit including a stepping motor, and a transmission member configured to transmit turning action of the stepping motor to the operation button to close and open the contact.

### CROSS REFERENCE TO RELATED APPLICATION

This application is related to and claims the benefit of Japanese Application No. 2013-108099 filed on 22 May 2013, the contents of which are herein incorporated by reference in their entirety.

### BACKGROUND

1. Field

The present invention relates to a switch that can manually and remotely be operated.

2. Related Art

Conventionally, a switch that can manually and remotely be operated, is provided with a contact that closes and opens an electric circuit and a electromagnet inside a case, and a handle on the case for closing and opening the contact by an external operation, for example. In the switch, a permanent magnet is attached to an inside of the handle while one of poles of the permanent magnet is oriented toward the electromagnet, and the direction of a current passed through the electromagnet is switched to attract and repel the permanent magnet, whereby the contact is closed and opened when the handle is operated (see Japanese Unexamined Patent Publication No. 2003-331674).

In the switch, illustrated in FIG. 1 of JP2003-331674, an electromagnet 13 attracts and repels a permanent magnet 15 to turn a handle 14, thereby switching a switch 11. Unfortunately, because a large impact force is applied to the permanent magnet 15 in switching the switch 11, the permanent magnet 15 is easily broken and easily causes a breakdown.

Because the permanent magnet 15 collides with an iron core of the electromagnet 13 in switching the switch 11, generation of a collision noise is not avoided, but the collision noise is harsh for a user.

Because the handle 14 is provided with the permanent magnet 15, the weight of the handle 14 is gained to increase an inertia force. For these reasons, the handle 14 malfunctions easily due to the external vibration or impact force.

When a ferromagnetic material is present near the switch 11, the permanent magnet 15 of the handle 14 malfunctions easily due to an influence of the ferromagnetic material. Therefore, such a technical countermeasure that a magnetic force of the permanent magnet 15 is strengthened or that a distance between the permanent magnets 15 and 15 is shortened is required to solve the drawbacks, and unfortunately design becomes troublesome. The preceding reference numerals pertain to FIG. 1 of JP2003-331674, which is made of record in the present application.

### BRIEF SUMMARY

A switch is provided for controlling the switch, the switch including a movable touch piece configured to be turned by manual operation of an operation button, a movable contact that is provided in the movable touch piece and configured to be brought into contact with and separated from a fixed contact to close and open a contact, and a remote control unit configured to be able to operate the operation button by remote control, the remote control unit including a stepping motor, and a transmission member configured to transmit turning action of the stepping motor to the operation button to close and open the contact.

The invention also provides a method for controlling a switch, the switch including a movable touch piece configured to be turned by manual operation of an operation button, a movable contact that is provided in the movable touch piece and configured to be brought into contact with and separated from a fixed contact to close and open a contact, and a remote control unit configured to be able to operate the operation button by remote control, where the method includes turning the operation button by a stepping motor constituting the remote control unit to close and open the contact, and reversely rotating the stepping motor to return a transmission member constituting the remote control unit to an initial position to enable manual operation.

### BRIEF DESCRIPTION OF THE DRAWINGS

FIGS. 1A and 1B are perspective views illustrating a switch according to a first embodiment of the present invention when the switch is viewed from different angles;

FIG. 2 is an exploded perspective view based on FIG. 1A;

FIG. 3 is an exploded perspective view based on FIG. 1B;

FIG. 4 is a sectional perspective view of a box-shaped base in FIG. 1;

FIGS. 5A and 5B are perspective and front views illustrating a remote control unit of the first embodiment, FIGS. 5C and 5D are perspective and front views illustrating a remote control unit of a second embodiment, and FIGS. 5E and 5F are perspective and front views illustrating a remote control unit of a third embodiment;

FIGS. 6A and 6B are sectional front and partially sectional perspective views of the switch in FIG. 1;

FIGS. 7A and 7B are a partially sectional perspective view of the switch in FIG. 1 and an entire perspective view of the remote control unit;

FIGS. 8A and 8B are sectional front and sectional rear views of the switch in FIG. 1;

FIGS. 9A and 9B are schematic rear views illustrating the switch before and after operation;

FIG. 10 is a block diagram illustrating control of the switch in FIG. 1;

FIG. 11 shows views schematically illustrating a mechanism of a controlling process of the switch in FIG. 1 and a timing chart; and

FIG. 12 shows views schematically illustrating a mechanism of a controlling process of the switch in FIG. 1 in a reverse direction and a timing chart.

### DETAILED DESCRIPTION

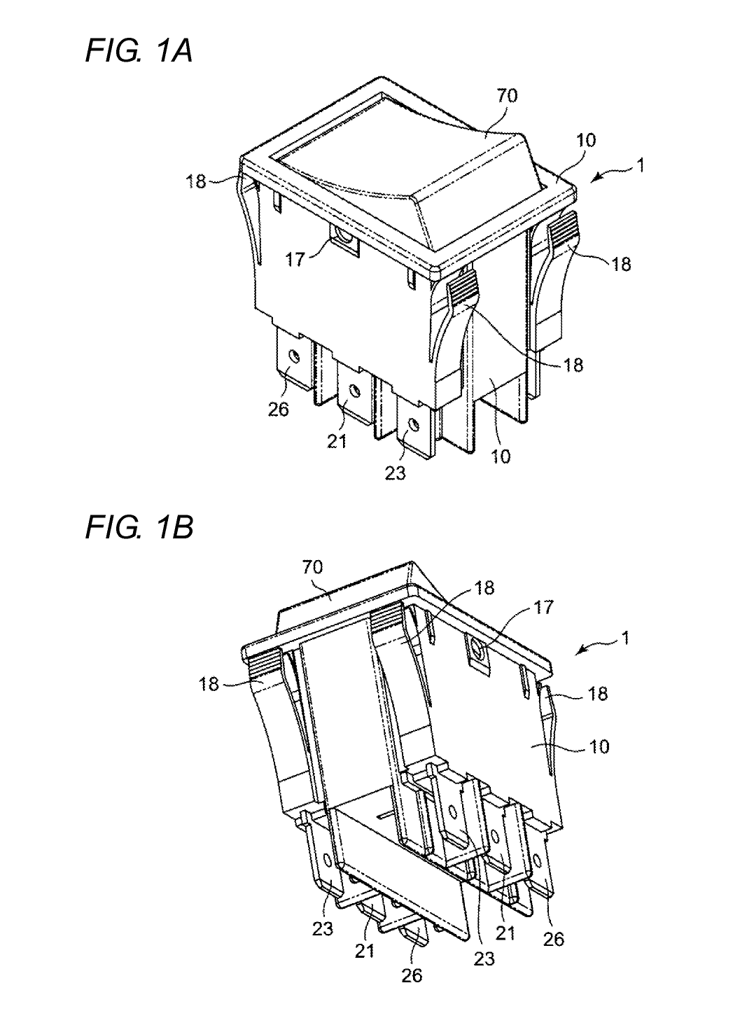

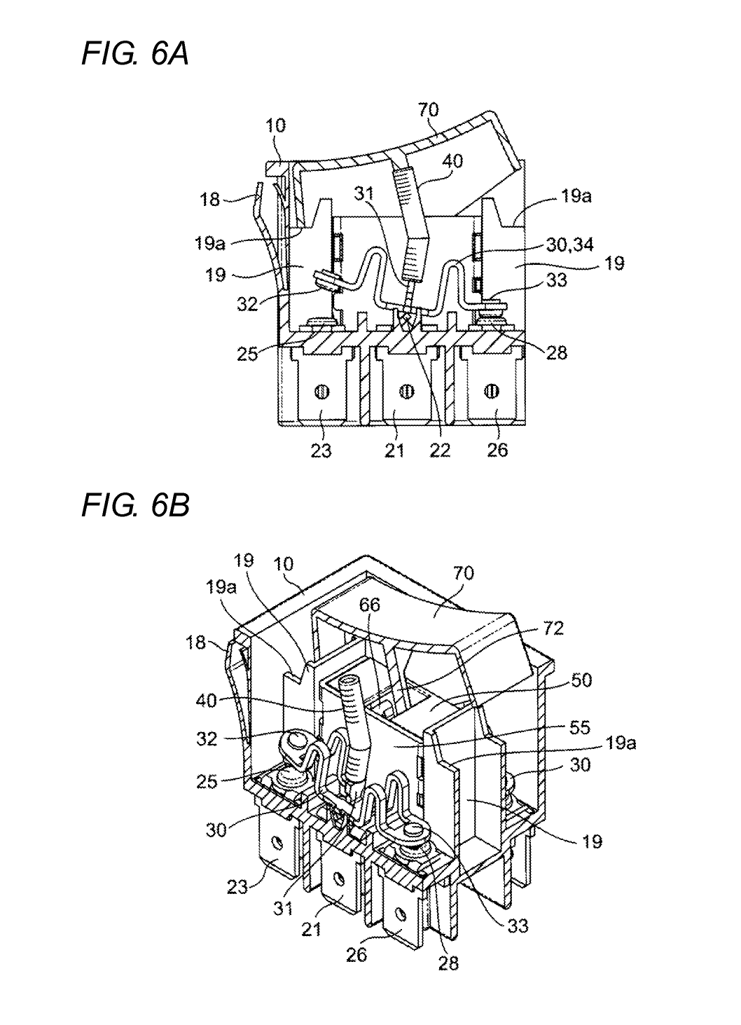

A switch according to an exemplary embodiment of the present invention will be described with reference to the accompanying drawings in FIGS. 1 to 12.

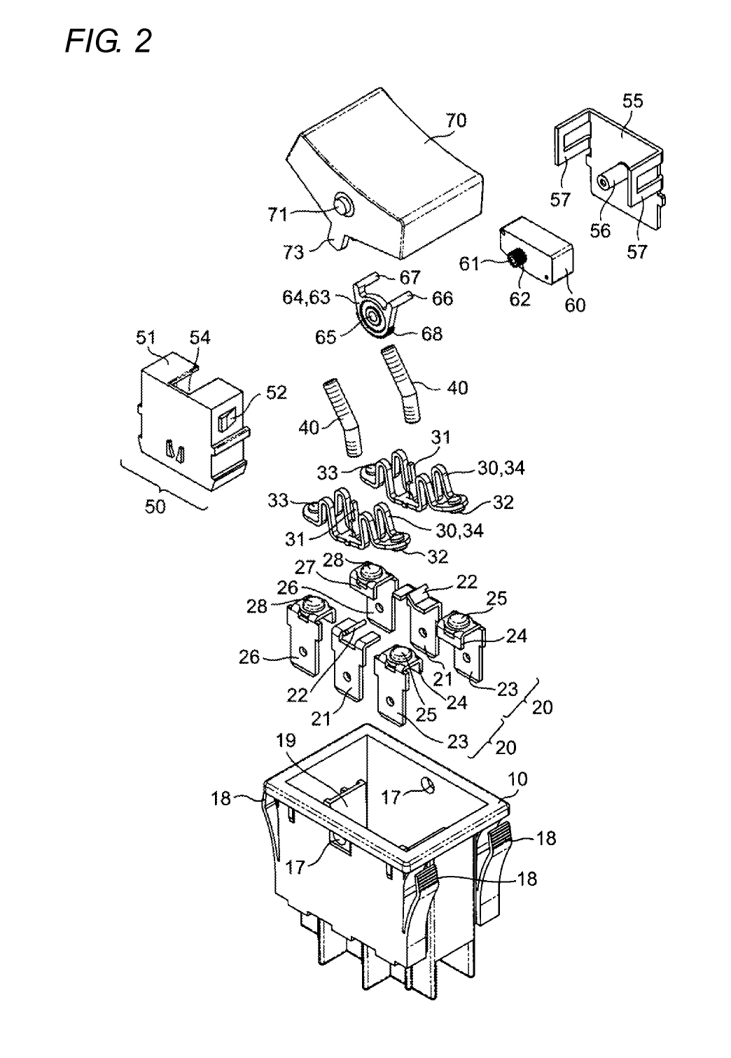

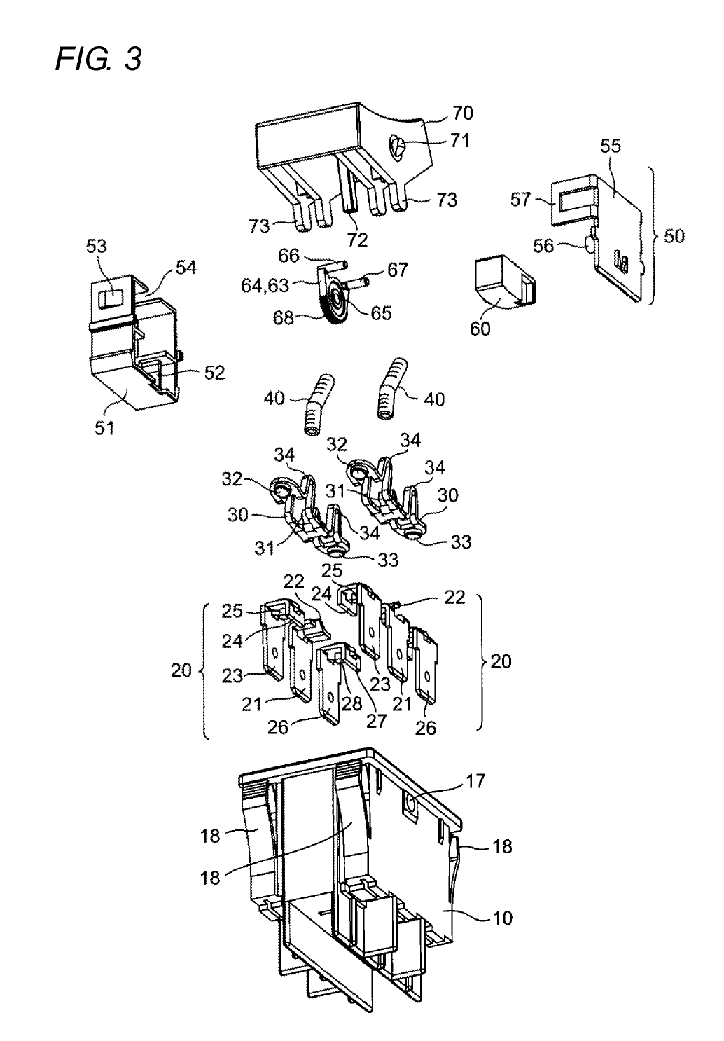

As illustrated in FIGS. 2 and 3, a switch 1 of the embodiment includes a box-shaped base 10, a contact mechanism 20, a movable touch piece 30, a coil spring 40, a remote control unit 50, and an operation button 70.

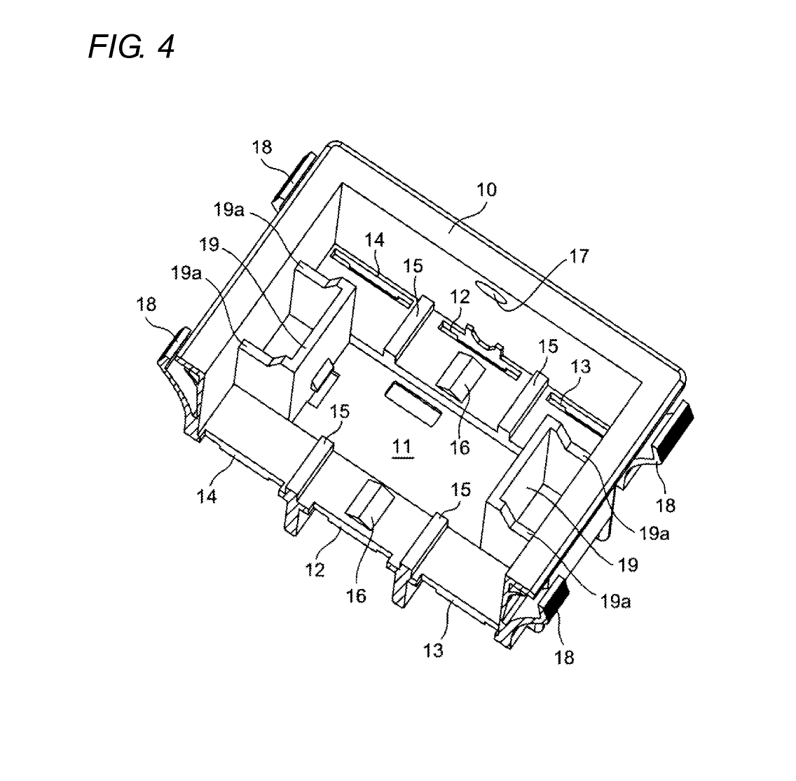

As illustrated in FIG. 4, three terminal holes 12, 13, and 14 are made in line in each of end portions on both sides of a positioning recess 11 provided in a center of a bottom surface of the box-shaped base 10. Insulating projections 15 and 15 are projected between the terminal holes 12 and 13 and between the terminal holes 12 and 14. A support projection 16 having a triangular shape in section is projected between the insulating projections 15 and 15. In the box-shaped base 10, shaft holes 17 and 17 are made on an identical axis in side surfaces opposed to each other. In the box-shaped base 10, a pair of retaining elastic pawls 18 and 18 is integrally molded in each of lateral surfaces opposed to each other.

In the box-shaped base 10, insulating walls 19 and 19 having a U-shape in section are integrally molded in inner surfaces opposed to each other. A positioning step 19a lower than the insulating wall 19 is formed in a base in an upper end edge portion of the insulating wall 19.

As illustrated in FIGS. 2 and 3, the contact mechanism 20 has a configuration in which fixed contact terminals 23 and 26 are disposed on both sides of a common fixed contact terminal 21. The common fixed contact terminal 21 and the fixed contact terminals 23 and 26 are press-fitted in the terminal holes 12, 13, and 14 of the box-shaped base 10, whereby the common fixed contact terminal 21 and the fixed contact terminals 23 and 26 are disposed in line in the edge portion of the bottom surface of the box-shaped base 10.

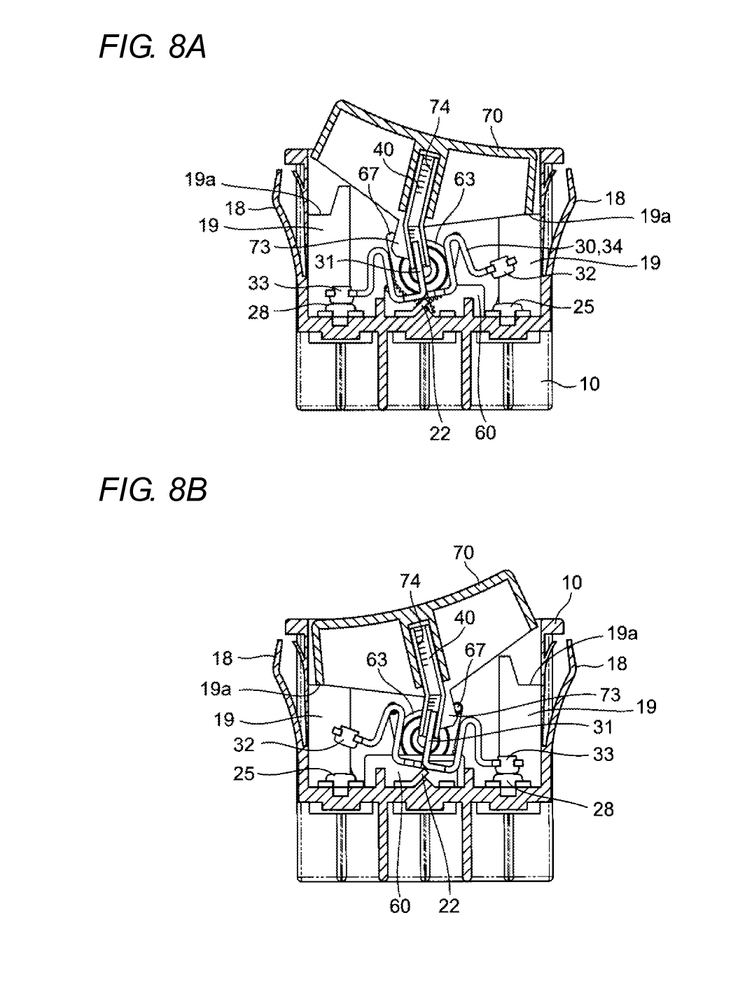

The common fixed contact terminal 21 is bent into a substantial L-shape in section, and a common fixed contact 22 is formed by cutting and raising an upper side portion of the common fixed contact terminal 21. When the common fixed contact terminal 21 is press-fitted in the terminal hole 12 of the box-shaped base 10, the common fixed contact 22 abuts on the support projection 16 of the box-shaped base 10, so that positioning can be performed with high assembly accuracy (see FIG. 8).

On the other hand, in the fixed contact terminals 23 and 26, leading edge portions 24 and 27 of upper side portions bent into the substantial L-shape in section are bent downward, and fixed contacts 25 and 28 are provided in the upper side portions. The leading edge portions 24 and 27 abut on the bottom surface of the box-shaped base 10 by press-fitting the fixed contact terminals 23 and 26 in the terminal holes 13 and 14 of the box-shaped base 10, and the positioning can be performed with high assembly accuracy.

As illustrated in FIGS. 2 and 3, the movable touch piece 30 is a press-forming product, a support projection 31 is cut and raised from a central portion of the movable touch piece 30, and movable contacts 32 and 33 are provided at both ends of the movable touch piece 30. Bent portions 34 bent into a substantial U-shape are formed between the support projection 31 and the movable contact 32 and between the support projection 31 and the movable contact 33. The bent portion 34 has the shape that can be operated by an operation piece 73 of the operation button 70 in order to enhance operating reliability.

As illustrated in FIG. 8, the support projection 31 of the movable touch piece 30 is inserted in a lower end portion of the coil spring 40, and an upper end portion of the coil spring 40 is inserted in a fitting hole 74 of the operation button 70, thereby providing a spring force of the coil spring 40 that turns the movable touch piece 30 in association with the operation of the operation button 70 to bias the movable touch piece 30 in one direction.

The remote control unit 50 is used to remotely operate the operation button 70. As illustrated in FIGS. 2 and 3, a transmission member 63 including a stepping motor 60 and a cam member is assembled and accommodated in an inner space formed by assembling a cover 55 in a unit case 51.

A pinion 62 that is of a small gear is attached to a turning shaft 61 of the stepping motor 60. In the transmission member 63 including the cam member, a pair of operating portions 66 and 67 laterally extends in parallel from an upper portion of a transmission member body 64, and a gear portion 68 is formed in a lower portion of the transmission member body 64.

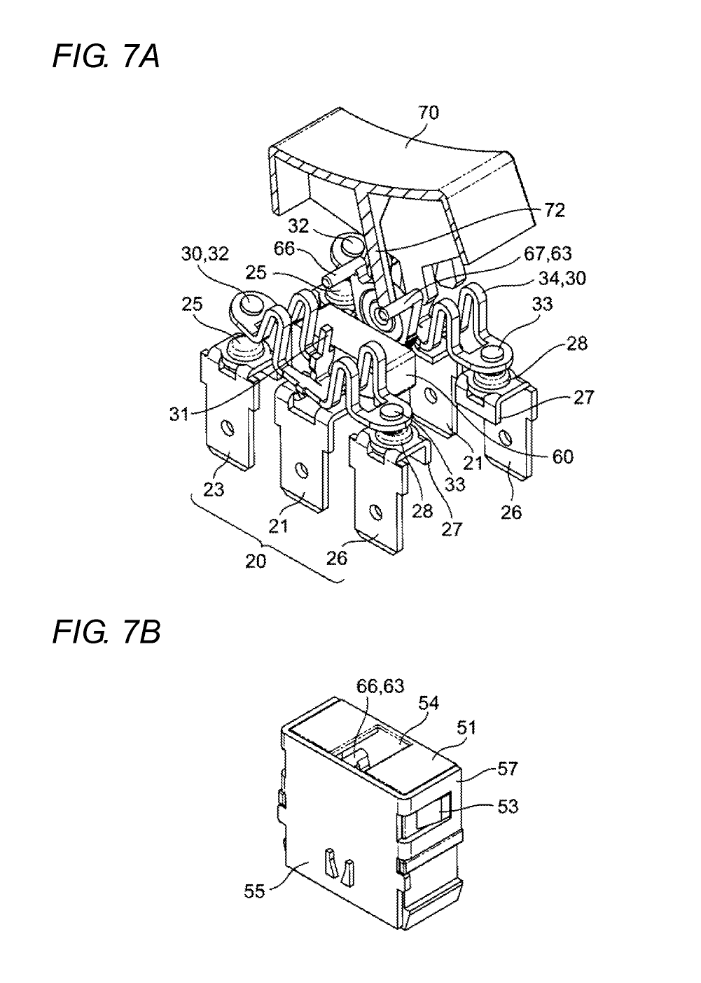

A spindle (not illustrated) projected in an upper stage of an inside surface of the unit case 51 is inserted in a shaft hole 65 of the transmission member 63 so as to be journaled in the shaft hole 65. The stepping motor 60 is assembled in a recess 52 (see FIG. 3) provided in a lower stage of the inside surface of the unit case 51. A retaining cylindrical shaft 56 projected from the inward surface of the cover 55 is fitted in a leading end of the spindle to prevent dropout of the transmission member 63. An elastic arm 57 of the cover 55 engages an engaging projection 53 of the unit case 51 to complete the remote control unit 50. At this point, as illustrated in FIG. 7B, the transmission member 63 can visually be recognized through an operating hole 54 of the remote control unit 50.

In the operation button 70, as illustrated in FIGS. 2 and 3, shafts 71 and 71 are projected on the identical axis in outside surfaces opposed to each other, and an operation rod 72 (see FIG. 3) is integrally formed. The operation rod 72 extends downward from the central portion of a ceiling surface of the operation button 70, and can abut on the operating portions 66 and 67 of the transmission member 63. In the operation button 70, the pair of operation pieces 73 and 73 is integrally molded on both the sides of the operation rod 72. The operation pieces 73 abut on the bent portions 34 of the movable touch piece 30 to forcedly turn the movable touch piece 30, thereby enhancing the operating reliability. The fitting hole 74 (see FIG. 8) is made between the pair of operation pieces 73 and 73 in order to insert the upper end portion of the coil spring 40.

The operation rod 72 is not necessarily integral with the operation button 70, but the operation rod 72 may separately be formed.

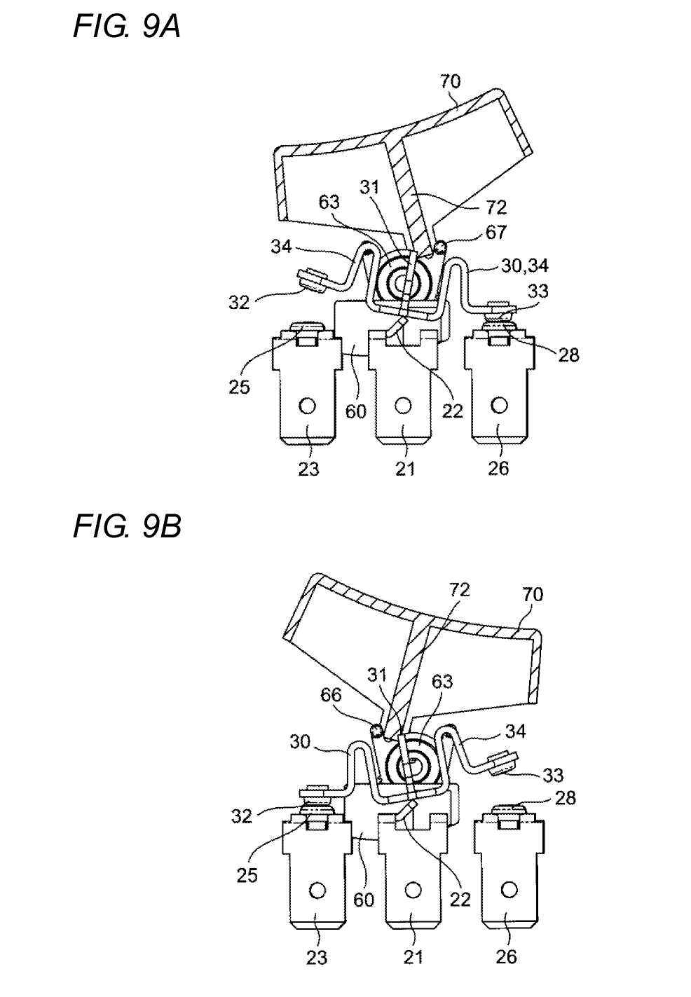

In the switch 1 of the embodiment, as illustrated in FIGS. 8 and 9, when one side of the operation button 70 is pressed down about the shafts 71 and 71, the coil spring 40 buckles, the movable touch piece 30 turns about the common fixed contact 22, and movable contact 33 abuts on the fixed contact 28. In order to enhance the operating reliability, the operation piece 73 of the operation button 70 presses the bent portion 34 of the movable touch piece 30 to forcedly turn the movable touch piece 30. At this point, the movable touch piece 30 is biased by the spring force of the coil spring 40, but rattling is not generated. An opening edge portion of the operation button 70 abuts on the positioning step 19a of the box-shaped base 10 to regulate the position of the operation button 70. Therefore, only the other side of the operation button 70 can be pressed down to perform a reverse operation.

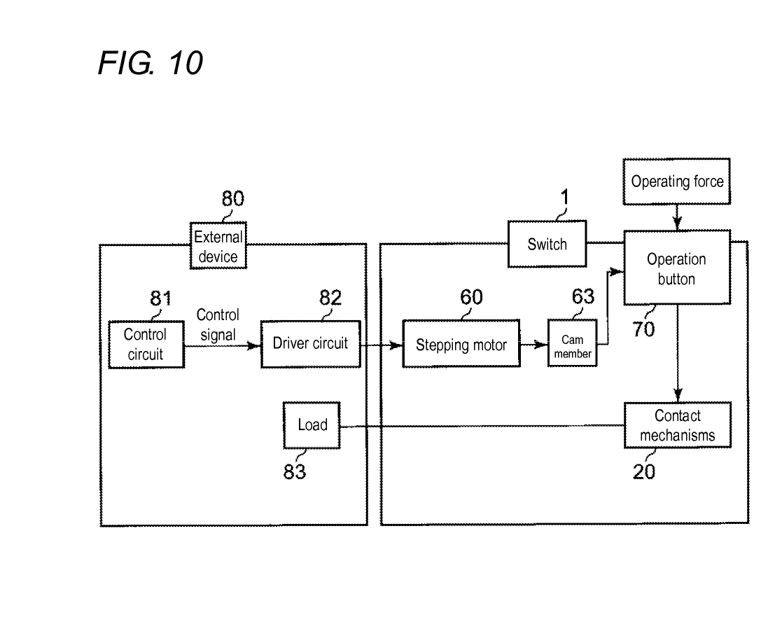

Action in the case that an external device 80 is connected to the switch 1 of the present invention will be described below with reference to FIGS. 10 to 12.

As illustrated in FIG. 10, a control circuit 81 of the external device 80 is connected to the stepping motor 60 of the switch 1 through a driver circuit 82. The contact mechanism 20 of the switch 1 is connected to a load 83 of the external device 80.

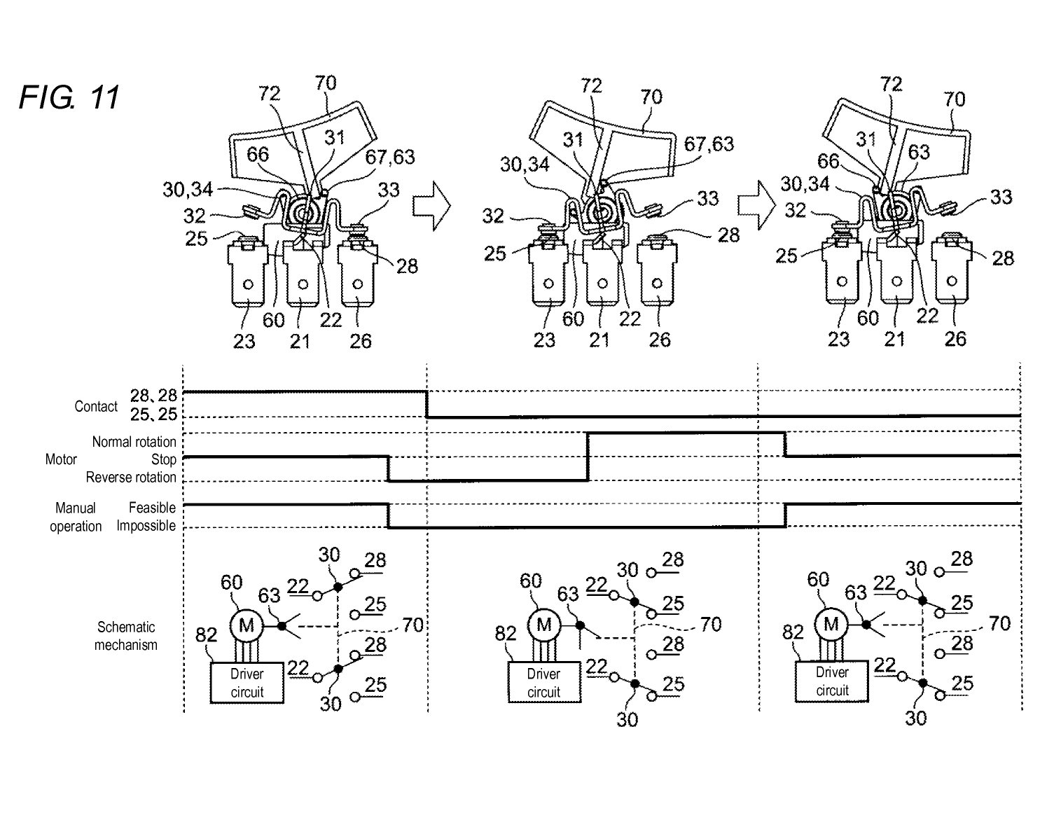

As illustrated in FIG. 11, the operation of the operation button 70 brings the movable contact 33 into contact with the fixed contact 28 to establish electric conduction to the load 83, and the operation of the operation button 70 also causes the opening edge portion of the operation button 70 to abut on the positioning step 19a of the box-shaped base 10 to regulate the position of the operation button 70.

When the control circuit 81 of the external device 80 outputs a control signal through the driver circuit 82, the stepping motor 60 turns to turn the transmission member 63 as illustrated in FIG. 11. Therefore, the operating portion 67 of the transmission member 63 presses the operation rod 72 of the operation button 70 to turn the operation button 70. When the operation button 70 reaches a predetermined angle, the operation button 70 turns reversely by the spring force of the coil spring 40 to turn the movable touch piece 30. As a result, the movable contact 32 comes into contact with the fixed contact 25 to establish the electric conduction to the load 83.

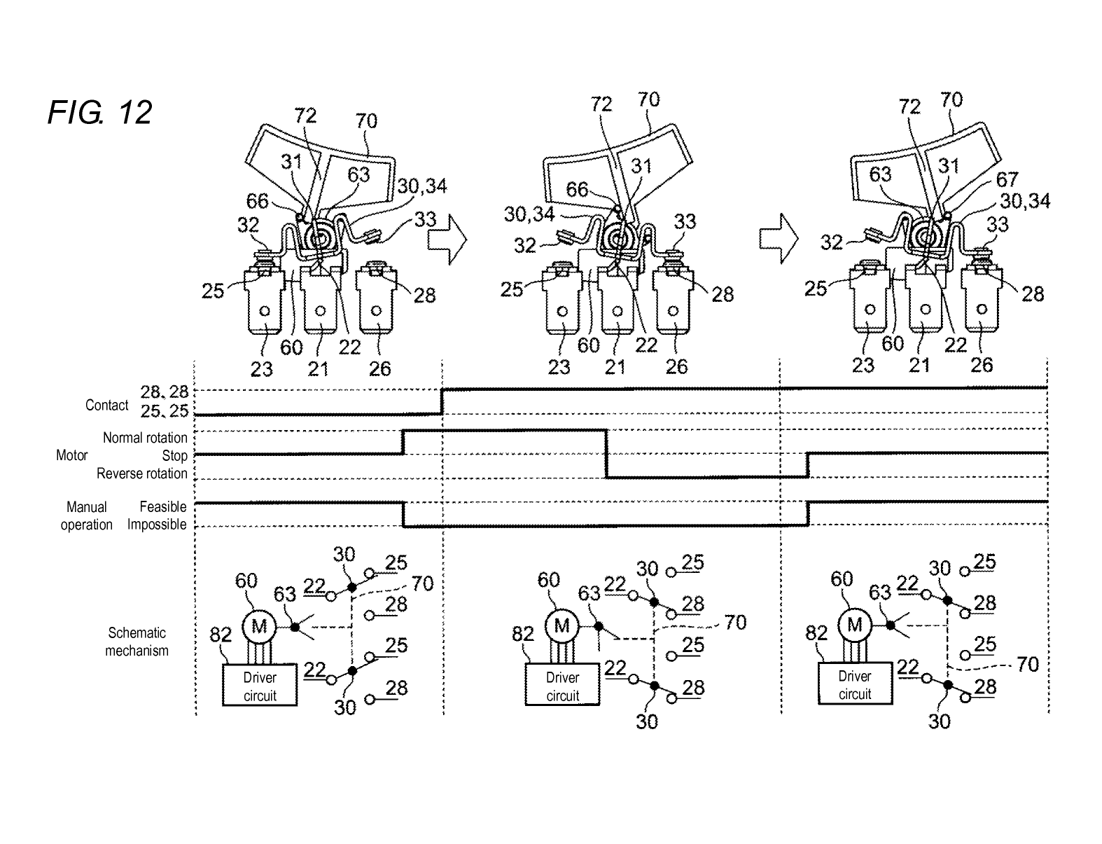

The stepping motor 60 is reversely rotated to turn the transmission member 63, and the operating portion 67 of the transmission member 63 separates from the operation rod 72 to return to the initial position. Therefore, the operation button 70 can manually be operated again. Then, the similar operation can be repeated in the reverse direction (see FIG. 12), and the switch 1 can continuously be operated by the remote control.

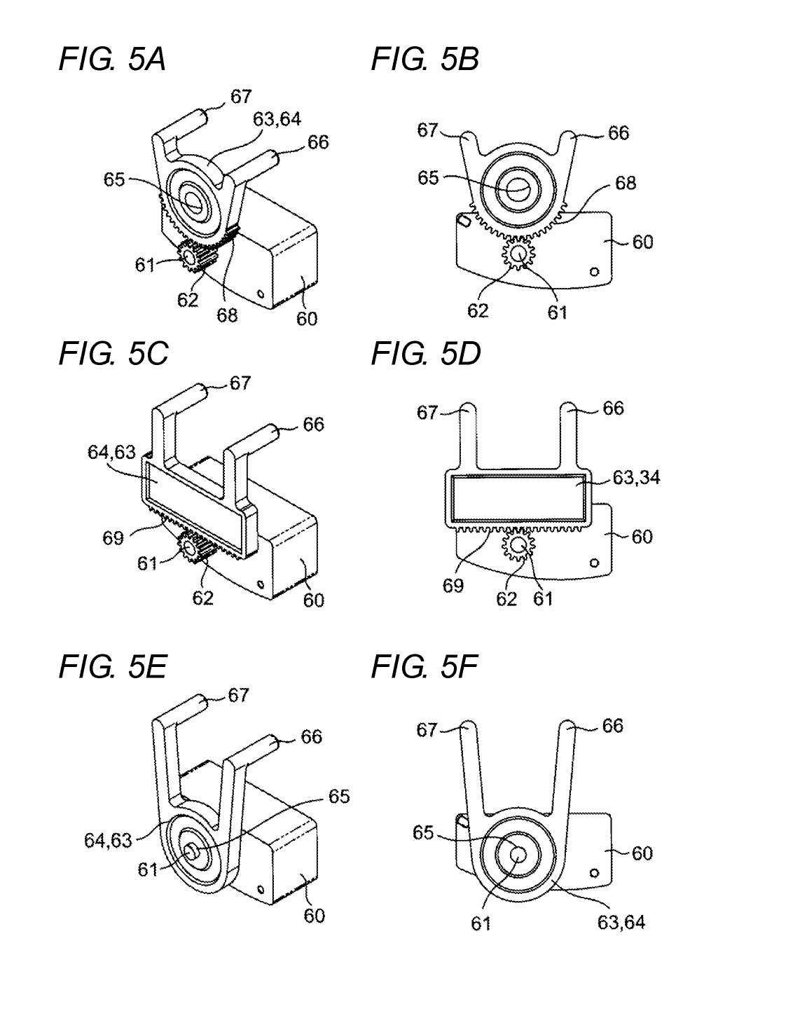

As illustrated in FIGS. 5A and 5B, in the first embodiment, the remote control unit 50 includes the stepping motor 60 and the transmission member 63, the stepping motor 60 includes the pinion 62, and the transmission member 63 constructed with the cam member includes the gear portion 68. However, the remote control unit 50 is not limited to the first embodiment.

For example, as illustrated in a second embodiment (FIGS. 5C and 5D), the remote control unit 50 may be constructed by a combination of the stepping motor 60 including the pinion 62 and the transmission member 63 including a rack 69.

According to the second embodiment, advantageously greater options are provided to enhance the degree of design freedom.

As illustrated in a third embodiment (FIGS. 5E and 5F), the transmission member 63 may directly be connected to the turning shaft 61 of the stepping motor 60.

According to the third embodiment, advantageously the number of components and assembling man-hours are reduced and a quick response characteristic can be obtained.

In the embodiments, the switch includes the two sets of contact mechanisms 20 and 20. Alternatively, the present invention may be applied to a switch having at least one contact mechanism.

The switch is not limited to the case that the movable touch piece 30 includes the movable contacts on both the sides thereof. Alternatively, the movable touch piece 30 may include one movable contact on at least one side.

The switch of the present invention is not limited to the embodiments, but the switch can be used in various applications.

Generally, the invention provides a switch in which the breakdown is hardly generated, the harsh collision noise is not generated, and the malfunction is hardly generated.

In accordance with one aspect of the present invention, a switch includes a movable touch piece configured to be turned by manual operation of an operation button, a movable contact that is provided in the movable touch piece and configured to be brought into contact with and separated from a fixed contact to close and open a contact, and a remote control unit configured to be able to operate the operation button by remote control. In the switch, the remote control unit includes a stepping motor and a transmission member configured to transmit turning action of the stepping motor to the operation button to close and open the contact.

Unlike the conventional switch in which a permanent magnet is used, the switch of the present invention is free from the breakage of the permanent magnet, and the breakdown is hardly generated.

The collision caused by the impact operation of the electromagnet in the permanent magnet or the component constituting the switch is eliminated, but the harsh collision noise is not generated.

Additionally, because the operation button is not provided with the permanent magnet, the inertia force decreases to prevent the malfunction caused by the external impact force or vibration, and the malfunction caused by the influence of the external ferromagnetic material can also be prevented.

In the switch, the transmission member of the remote control unit may be a cam member configured to transmit the turning action of a turning shaft of the stepping motor to the operation button as turning action.

Accordingly, the design and the control can be performed in various manners by the use of the cam member, and a degree of design freedom is enhanced.

The cam member may directly be connected to the turning shaft of the stepping motor.

In the switch, the transmission member of the remote control unit may include a gear portion configured to engage a pinion connected to a turning shaft of the stepping motor.

Accordingly, the use of a rack and pinion mechanism widens a range of selection to enhance the degree of design freedom.

In the switch, the movable touch piece disposed on both sides of the remote control unit may be configured to be operated by the operation button.

Accordingly, plural contacts are closed and opened, so that a general-purpose switch can be obtained.

The invention also encompasses a method for controlling a switch including a movable touch piece configured to be turned by manual operation of an operation button, a movable contact that is provided in the movable touch piece and configured to be brought into contact with and separated from a fixed contact to close and open a contact, and a remote control unit configured to be able to operate the operation button by remote control. The method includes turning the operation button by a stepping motor constituting the remote control unit to close and open the contact, and reversely rotating the stepping motor to return a transmission member constituting the remote control unit to an initial position to enable manual operation.

According to the present invention, advantageously the switch in which the operation button can manually be operated is obtained again by returning the transmission member to the initial position.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A switch comprising:
a movable touch piece configured to be turned by manual operation of an operation button;
a movable contact that is provided in the movable touch piece and configured to be brought into contact with and separated from a fixed contact to close and open a contact; and
a remote control unit configured to be able to operate the operation button by remote control,
the remote control unit comprising:
a stepping motor; and
a transmission member configured to transmit turning action of the stepping motor to the operation button to close and open the contact.

2. The switch according to claim 1, wherein the transmission member of the remote control unit is a cam member configured to transmit turning action of a turning shaft of the stepping motor to the operation button as turning action.

3. The switch according to claim 1, wherein the transmission member of the remote control unit comprises a gear portion configured to engage a pinion connected to a turning shaft of the stepping motor.

4. The switch according to claim 1, wherein the movable touch piece disposed on both sides of the remote control unit is configured to be operated by the operation button.

5. A method for controlling a switch, the switch comprising a movable touch piece configured to be turned by manual operation of an operation button, a movable contact that is provided in the movable touch piece and configured to be brought into contact with and separated from a fixed contact to close and open a contact, and a remote control unit configured to be able to operate the operation button by remote control,
the method comprising:
turning the operation button by a stepping motor constituting the remote control unit to close and open the contact; and
reversely rotating the stepping motor to return a transmission member constituting the remote control unit to an initial position to enable manual operation.

6. The switch according to claim 2, wherein the movable touch piece disposed on both sides of the remote control unit is configured to be operated by the operation button.

7. The switch according to claim 3, wherein the movable touch piece disposed on both sides of the remote control unit is configured to be operated by the operation button.
